(19) United States
(12) Patent Application Publication
(10) Pub. No.: US 2005/0097548 A1
(43) Pub. Date: May 5, 2005

(54) Systems and methods for developing and distributing software components

(76) Inventors: Brian Joseph Dillenburg, Aurora, IL (US); Steven Bruce McCray, Naperville, IL (US); Zhihong Sun, Darien, IL (US); Hakan Axel Valdemar Hjalmers, Blackrock (IE); John William Morrissey, Chelmsford, MA (US)

Correspondence Address: Dean D. Small;Armstrong teasdale LLP, Suite 2600, One Metropolitan Square, St. Louis, MO, 63102, US

(21) Appl. No.: 10/699,057

(22) Filed: Oct. 31, 2003

(51) Int. Cl. G06F 9/445

(52) U.S. Cl. 717/177; 717/172

(57) ABSTRACT

A method for distributing software components to computer stations that analyze products is described. The method includes obtaining a software component including information used by a computer station which communicates with a test station to analyze a product, and distributing the software component to the computer station automatically based on at least one of an identification of the test station and an identification of the product.

### BACKGROUND OF THE INVENTION

This invention generally relates to the development and distribution of software applications and components and more particularly, relates to software applications and software components used in test stations to test products and the like.

Today, manufacturing processes rely more and more on automatic and computer controlled testing of products. To facilitate computer control, the products may be tested at test stations deployed throughout manufacturing facilities. Test stations perform a variety of analysis associated with the manufacture and verification of products. By way of example only, test stations include a computer, such as a personal computer, and an instrument of some form that operates upon a product. The computer controls operation of the instrument based on software applications stored on the computer. Each software application includes one or more software components. The software components used by the test stations are subject to frequent updates, revisions and replacements. Heretofore, it has been time consuming to install, modify or update the software applications on the computers at each test station.

Conventionally, a technician or operator updates the test stations utilizing a fixed collections of software components. The fixed collection was often bundled and distributed as a package saved on a diskette in an install program. When the install program was executed, it placed the collection of software components in the appropriate sub-directories and folders in memory on the computer at the test station. However, often, software components are unique to a single test station and a manufacturing facility may have several dozen test stations. The unique software components could not be bundled with the fixed collections on the diskette because the install program was unable to effectively discriminate between different test stations and select the appropriate unique software components. Also, it was difficult to manage a timely distribution of the diskettes, where different diskettes each had a software component unique to a particular test station. Also, it is time consuming and a substantial draw on resources to install individually at each test station, updates and new software components.

Further, in the past, it has been difficult to utilize generalized mass distribution techniques because of the unique aspects of some or all test stations. For example, some software components may only be intended for installation on one test station, or different combinations of software components intended for installation on different test stations. Conventional mass distribution systems and processes are unable to manage the individualized distribution of software components on a test station by test station basis.

Hence, a need remains for methods, systems and databases that support the development and automated distribution of software applications and software components.

### BRIEF DESCRIPTION OF THE INVENTION

In one embodiment, a method for distributing software components to computer stations that analyze products is provided. The method includes obtaining a software component including information used by a computer station which communicates with a test station to analyze a product. The method includes distributing the software component to the computer station automatically based on at least one of an identification of the test station and an identification of the product.

In another embodiment, a management system database is provided. The database is configured to be used with a computer station that operates an instrument when analyzing a product. The database stores software components that are configured to be executed by the computer station to communicate with and operate the instrument to analyze the product. The database automatically accesses the software components based on identification of at least one of the computer station, the instrument and the product.

In yet another embodiment, a system is provided. The system includes a computer station configured to control operation of an instrument as the instrument analyzes a product. The computer station controls the instrument based on at least one of an equipment file set and a test program set. The system includes a management system database in communication with the computer station. The database stores at least one of an equipment file set and test program set. The database is accessible by the computer station, where the computer station controls the instrument during analysis of the product based on at least one of an equipment file set and a test program set.

### BRIEF DESCRIPTION OF THE DRAWINGS

FIG. 1 illustrates a block diagram of a system for distributing software components formed in accordance with an embodiment of the invention.

FIG. 2 illustrates a flowchart of a method for distributing software components in accordance with an embodiment of the invention.

FIG. 3 illustrates a block diagram of a system for developing software components formed in accordance with an embodiment of the invention.

FIG. 4 illustrates a developer file used to create information supplied within the systems of FIGS. 1 and 3 in accordance with an embodiment of the invention.

FIG. 5 illustrates a flowchart of a method for developing software components in accordance with a embodiment of the invention.

### DETAILED DESCRIPTION OF THE INVENTION

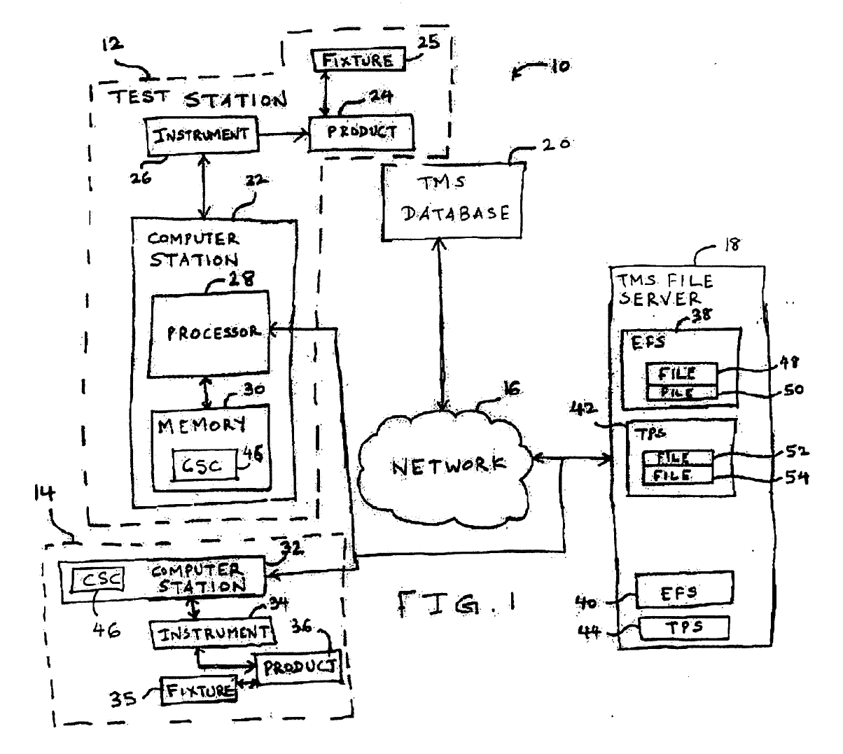

FIG. 1 illustrates a system 10 for distributing software components. System 10 includes test stations 12 and 14, a network 16, a test management system (TMS) file server 18, and a TMS database 20. Test station 12 includes a computer station 22, a product 24, a fixture 25 and an instrument 26. Computer station 22 includes a processor 28 and a memory 30. Test station 14 may include one or more of a computer station 32, an instrument 34, and a fixture 35. Products 24 and 36 are held in fixtures 25 and 35, respectively.

Test station 12 may include additional instruments besides instrument 26 to analyze product 24. Moreover, test station 12 may also include additional computer stations besides computer station 22 and analyze additional products in addition to product 24. Similarly, test station 14 may include additional instruments, and additional computer stations. In an alternative embodiment, instruments 26 and 34 may be operationally, via a link or a network, to remotely located computer stations, respectively. Optionally, computer stations 22 and 32 may be remote from test stations 12 and 14, respectively.

The terms “analysis”, “analyze” and “test” as used throughout are intended to be used interchangeably and broadly, such as to refer to a test step, a series of test steps, a complete test sequence, a calibration step, series or sequence, a communications step, series or sequence, a configuration step, series or sequence, and the like. The terms analysis, analyze and test may constitute set up, measurement, verification, validation or testing of protocols, mechanical and/or electrical properties and/or standards.

TMS file server 18 stores equipment file sets (EFSS) 38 and 40, and test program sets (TPSs) 42 and 44. TMS database 20 stores addresses of EFSs 38 and 40 and TPSs 42 and 44. The addresses are used to locate EFSs 38 and 40 and TPSs 42 and 44 within TMS file server 18. In an alternative embodiment, EFSs 38 and 40 and TPSs 42 and 44 are stored within TMS database 20 and the addresses are stored within TMS file server 18. The EFSs 38 and 40 and TPSs 42 and 44 store software components. The term “software components”, as used throughout, is not limited to files, but broadly refers to source codes, object codes, firmware, computer programs and any other medium that controls or is executed or operated upon by a computer, a controller or the like. EFS 38 includes files 48 and 50. TPS 42 includes files 52 and 54. Each file 48, 50, 52 and 54 stores a single, individual software component.

EFSs 38 and 40 include a set of software components that, when executed by the corresponding computer stations 22 and 32, directs or controls the corresponding instruments 26 and 34 to analyze the corresponding products 24 and 36, respectively. The set of software components within EFS 38 or 40 may form a single software application. EFSs 38 and 40 may be uniquely associated with the corresponding test stations 12 and 14, independent of the products 24 and 36. For example, EFS 38 may be uniquely associated with one type of instrument 26, one type of fixture 25 and one type of computer station 22, where each type may include more than one revision.

TPSs 42 and 44 include a set of software components that when executed by the corresponding computer stations 22 and 32, direct or control corresponding instruments 26 and 34 to analyze the corresponding products 24 or 36. The TPSs 42 and 44 differ from the EFSs 38 and 40 in that TPSs 42 and 44 are unique to the corresponding products 24 or 36. By way of example only, TPS 42 may uniquely correspond to product 24, regardless of whether product 24 is being analyzed by test station 12 or test station 14.

Moreover, in an alternative embodiment, TPS 42, including files 52 and 54, is associated with a subset of instruments (not shown), a subset of fixtures (not shown), a subset of test stations (not shown), and/or a subset of computer stations. The subsets operate on product 24. For example, TPS 42 includes a test sequence file that is executed by the subset of computer stations to test product 24 that can be connected to the subset of fixtures. Product 24 is tested by the subset of computer stations that instruct the subset of instruments to operate upon product 24. As another example, TPS 42 includes a calibration file that is executed to calibrate the subset of instruments that can manipulate product 24 when product 24 is being tested. An example of the subset of instruments is a subset that includes 1-5 instruments from a larger group of instruments. An example of the subset of fixtures is a subset that includes 1-6 fixtures from a larger group of fixtures. An example of the subset of computer stations is a subset that includes 1-6 computer stations from a larger group of computer stations. An example of the subset of test stations is a subset that includes 1-7 test stations from a larger group of test stations. Similarly, TPS 44, including files (not shown), is associated with a subset of instruments, a subset of fixtures, a subset of test stations, and a subset of computer stations that operate on product 36.

The term “processors”, as used herein, is not limited to just those integrated circuits referred to in the art as computers, but broadly refers to computers, microcontrollers, microcomputers, programmable logic controllers, application specific integrated circuits, servers, systems, and other programmable circuits, and these terms are used interchangeably herein. Examples of memory 30 include a read-only memory (ROM) and a random access memory (RAM).

Computer stations 22 and 32 store common software components (CSCs) 46 that may be used by multiple test stations 12 and 14. Examples of common software components 46 include a source code such as a C program source code, networking software such as Netscape™ and Internet Explorer™, operating systems such as UNIX™, Windows™ 2000 or Windows™ XP™, and a database access software. A software imaging tool may be used as an installation program, such as Ghost™, to install common software components 46 on computer station 22 or computer station 32. For example, if processor 28 on test station 12 crashes, the installation program is used to copy common software components 46 from computer station 32 and install the copy into memory 30 of computer station 22. The software imaging tool captures a snapshot of common software components 46 onto processor 28, which can be restored to a prior working state by applying an image of common software components 46. The operating system may support a plug and play operation which reduces various permutations of images used to support processor types with different hardware.

The term “product” as used throughout is also intended to be used broadly, such as to refer generally to any physical item or structure, including mechanical and/or electrical devices, systems, components, assemblies, subassemblies, and the like. By way of example only, the products of 24 and 36 may include, among other things, a printed circuit board or combinations of the printed circuit board assemblies in a shelf or a system. Other examples of products 24 and 36 include a module, a circuit pack, a field replaceable unit (FRU), a processor, a memory, and a cable.

The term “instrument” as used throughout is intended to be used broadly, such as to refer generally to a mechanism, an interface, a device, a process and the like, that acts on or functions as an intermediary or an agent between a product and a computer or controller regardless of whether the computer or controller is controlled by software, firmware, or hardware. Examples of instruments 26 and 34 include devices that provide an electrical stimulus or measurement capability. Other examples of instruments 26 and 34 include a power supply, a signal generator, a communication analyzer, and a frequency counter. The types of test stations 12 and 14 vary with the types of instruments 26 and 34. The types of test stations 12 and 14 also vary with power and signal requirements of respective products 24 and 36 or respective fixtures 25 and 35. An example of test stations 12 and 14 includes a rack and automated test equipment (ATE). Examples of fixtures 25 and 35 include mechanical and electrical interfaces to which products 24 and 36 are connected for testing. Other examples of fixtures include an interface, a test adapter, and a test shelf.

Examples of network 16 include a local area network (LAN) and a wide area network (WAN). EFS 38 may include a communication file, a configuration file, a calibration file, a test executive file, a test sequence file, or a specification file. TPS 42 may include a communication file, a configuration file, a calibration file, a test sequence file, a specification file, or a test step execution file. Communication files are executed by the processor 28 to enable communication between instrument 26, product 24, computer station 22, and network 16. Configuration files are executed by the processor 28 to configure computer station 22. Calibration files are executed by the processor 28 to calibrate instrument 26. Test executive files stored within EFS 38 are part of an infrastructure that runs TPS 42. Specification files are accessed by the processor 28 to provide specifications of product 24 to computer station 22. Test step execution files are executed by the processor 28 to perform specific analysis steps, for example, less than a complete analysis sequence, upon product 24.

Computer station 22 analyzes product 24 by controlling instrument 26 based on the software components in EFS 38 or TPS 42. As an example, computer station 22 may test a circuit pack by providing instructions stored within EFS 38 or TPS 42 to a signal generator, which constitutes the instrument 26 that generates a signal to test the circuit pack. Alternatively, the computer station 22 may test a module by providing instructions stored within EFS 38 or TPS 42 to a power supply, which constitutes the instrument 26 that manipulates an amount of power provided to test the module.

The set of files 48 and 50 that form the EFS 38 defines a single station specific test solution. Files 48 and 50 within EFS 38 store a station specific test solution that is unique to a type of test station 12 and, once stored in memory 30, directs computer station 22 in how to control instrument 26 to analyze products, including product 24. Files 48 and 50 may be specific to a type and/or revision of test station 12, fixture 25 and/or instrument 26. When the type or revision of the test station 12, fixture 25 or instrument 26 is changed, the files 48 and 50 may be replaced with one or more new software components so that EFS 38 stores a new station specific test solution or modifies an existing station specific test solution.

As an example, the instrument 26 may be a signal generator and the EFS 38 may store a station specific test solution configured to verify frequencies of signals generated by the signal generator. When the signal generator is revised to add additional frequencies, the station specific test solution is similarly revised. Hence, the station specific test solution is modified to verify that the signal generator generates signals of additional frequencies and the EFS 38 stores a new station specific test solution in one of files 48 and 50. Similarly, files (not shown) within EFS 40 store a station specific test solution that is unique to test station 14. In other words, each file within EFS 40 is an individual software component that defines a station specific test solution that relates specifically to instrument 34, computer station 32, and fixture 35. As an example, EFS 40 may include a calibration sequence that when executed, instructs a power supply to supply a specific amount of power to an FRU tested on test station 14. As another example, EFS 40 may include a station test sequence that, when executed, instructs a signal generator to generate a particular sequence of signals that are supplied to test a circuit pack on test station 12.

The set of files 52 and 54 that form the TPS 42 define a single product specific test solution. As explained above, files 52 and 54 within TPS 42 are uniquely associated with product 24 and are associated with the subset, including instrument 26, of instruments, associated with the subset, including fixture 25, of fixtures, or associated with the subset, including computer station 22, of computer stations. Once stored in memory 30, when TPS 42 is executed, instrument 26 performs a product specific test solution. As an example, the product 24 may be a connector and the TPS 42 may store a product specific test solution configured to verify electrical conduction of each signal pin through the connector. When the connector is revised to add an additional signal pin, the product specific test solution is similarly revised. Hence, the product specific test solution is modified to instruct the instrument 26 to verify conduction of the new signal pin and the TPS 42 stores a new product specific test solution in one of files 52 and 54. Similarly, as explained above, files (not shown) within TPS 44 store a product specific test solution that is uniquely related to product 36. Moreover, as explained above, the files within TPS 44 are associated with the subset, including fixture 35, of fixtures, associated with the subset, including instrument 34, of instruments, or associated with the subset, including computer station 32, of computer stations. When TPS 44 is executed, instrument 34 performs a product specific test solution. As an example, TPS 44 may include a product configuration sequence that configures computer station 32 to execute a product test sequence to test a circuit pack on test station 14.

TPS 42 automates the process of taking measurements or communicates with product 24 under test to ensure that the product is programmed and configured correctly. For example, when TPS 42 is executed by the computer station 22, the instrument 26 may automatically measure an electrical or mechanical property, such as, for example, signal frequency, current amplitude, voltage amplitude, impedance, attenuation, signal-to-noise ration (SNR), power output, elasticity, flexibility, thermal expansion, heat transfer, durability, hermetic seals, or strength, of the product 24. TPS 42 creates a software automation exercise that developers, such as engineers, use to-access durability and reliability of the product 24. Each of EFS 38, EFS 40, TPS 42, and TPS 44 may be changed at any time, such as via a software release process, described below.

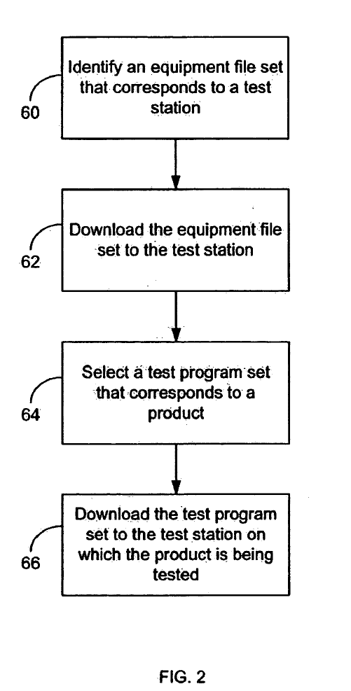

FIG. 2 is a flowchart illustrating a method for distributing software components such as by way of example only, from EFS 38, EFS 40, TPS 42, and TPS 44 from TMS file server 18 to corresponding test stations 12 and 14. EFS 38 or TPS 42 are executed after being downloaded to computer station 22. Different mechanisms may be used to deliver EFS 38, EFS 40, TPS 42, and TPS 44 to respective test stations 12 and 14.

In 60, an EFS is identified that corresponds to a designated test station. In 62, the EFS is downloaded to the test station. In 64, a TPS is selected that corresponds to a designated product. In 66, the TPS is downloaded to the test station on which the product is being tested.

Next, the method of FIG. 2 is explained where implemented with the system of FIG. 1. In 60, a station update program, such as an auto update program, stored within computer station 22, identifies EFS 38 in TMS file server 18 based on a type of test station 12 and downloads, in 62, the EFS 38 to test station 12. The station update program may initiate the process in FIG. 2 each time the station update program is run. Alternatively, the station update program may be run once to download, in 62, EFS 38 to computer system 22 for each change in the EFS 38. The station update program queries TMS file server 18 for EFS 38 based on query information specifying the type of test station 12. Optionally, the query information may also identify the revision of the test station 12. The station update program identifies the corresponding EFS 38 and automatically copies the EFS 38 from the TMS file server 18 to an appropriate destination location in memory 30 of computer station 22. The station update program enables an automatic delivery of updates of EFS 38 to test station 12 without running a new install processes or a service pack on test station 12.

Once a TMS operator interface is initiated on computer station 22, an operator of test station 12 selects, in 64, TPS 42 that is within TMS file server 18. Other TPSs (not shown) besides TPS 42 could also be available to the operator of test station 12. The selection, in 64, initiates a process, such as a TPS load process, which accomplishes numerous tasks for execution of a test solution for product 24. One of these tasks is to download, in 66, one or more of TPS 42 to memory 30 in computer station 22. During the download, in 64, files 48 and 50 associated with TPS 42 in TMS file server 18 are copied to an appropriate destination location within memory 30 of computer station 22. The process enables the TPS 42 to be changed dynamically by the operator without running a complete new install process or a service pack on test station 12. Alternatively, the EFS 38, EFS 40, TPS 42, and TPS 44 may be downloaded to respective test stations 12 and 14 periodically, for instance, every two weeks.

Common software components 46 may not be updated as frequently as EFS 38, EFS 40, TPS 42, or TPS 44. Hence, if computer stations 22 and 32 have a copy, such as, for instance, a default configuration, of common software components 46, they need not frequently download the common software components 46. Optionally, common software components 46 may be installed first into memory 30 of computer station 22, EFS 38 may be downloaded second from the TMS file server 18 to the memory 30, and TPS 42 may be downloaded third from the TMS file server 18 to the memory 30. Alternatively, common software components 46 may be installed, and EFS 38 and TPS 42 may be downloaded to memory 30 in any other order or sequence or in parallel with each other.

An example of a procedure for downloading EFS 38, EFS 40, TPS 42, and TPS 44 from TMS file server 18 to corresponding test stations 12 and 14 is provided next. In the example, the method stores and identifies within TMS file server 18, a calibration file within EFS 38 that calibrates a signal generator to generate a voltage signal of 200 voltage alternating current (VAC). The voltage signal is generated to test the functionality of a transformer on test station 12. On identifying the calibration file, the calibration file is automatically downloaded from TMS file server 18 to memory 30 of computer station 22. The calibration file is executed by processor 28 to test the functionality of the transformer supplied with a 200 VAC signal. The operator selects, on the TMS operator interface, the transformer to be tested and TPS 42 is identified by processor 28 to test whether the transformer is a 1:2 transformer. TPS 42 includes a product test sequence to test whether the transformer is a 1:2 transformer. Once the operator selects the transformer to be tested, TPS 42 is downloaded from TMS file server 18 into memory 30 of test station 12 and is executed by processor 28 to test whether the transformer is a 1:2 transformer.

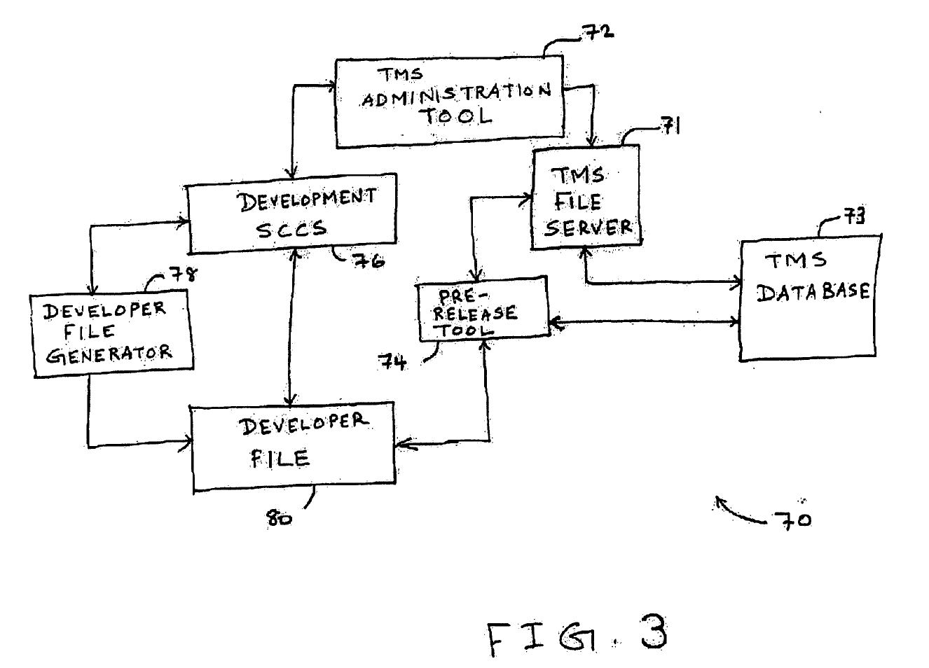

FIG. 3 illustrates an embodiment of a development system 70 for developing software components. The development system 70 includes a TMS file server 71, a TMS administration tool 72, a TMS database 73, a pre-release tool 74, a development source code control system (SCCS) 76, a developer file generator 78, and a developer file 80. The developer file 80 may include work books, such as a Microsoft™ Excel™ workbook.

The development system 70 is used by a developer, such as an engineer, a physicist, or a scientist, to create or modify relationships between at least one of products 24 and 36 to be tested, revisions of the products, instruments 26 and 34 used to analyze respective products 24 and 36, types of test stations 12 and 14 that test respective products 24 and 36, types of fixtures 25 and 35 used with the respective products 24 and 36, a unique files listing, and a shared files listing, described below, that are parsed to obtain EPSs 38 and 40 and TPSs 42 and 44. The relationships are created or modified by manually entering the relationships in developer file 80.

For instance, the developer creates the relationship by manually entering in a Microsoft™ Excel™ workbook, identification information for a 3-pin connector, for a signal generator that provides a 20 voltage direct current (VDC) signal to the 3-pin connector, an adapter that couples to the 3-pin connector, and an algorithm that includes steps for testing the 3-pin connector that is connected to the adapter and that is provided with the 20 VDC signal. Optionally, the developer may modify the relationship by manually replacing in a Microsoft™ Excel™ workbook, identification information for the 3-pin connector with identification information for a 4-pin connector, by replacing the signal generator that provides a 20 VDC signal to the 3-pin connector with a signal generator that provides a 40 VDC signal to the 4-pin connector, by replacing the adapter that couples to the 3-pin connector with an adapter that couples to the 4-pin connector, and by replacing the algorithm that includes steps for testing the 3-pin connector with an algorithm that includes steps for testing the 4-pin connector that is provided with the 40 VDC signal.

As explained above, the developer file 80 includes various relationships between products 24 and 36 to be tested, revisions of the products, instruments 26 and 34 used to test respective products 24 and 36, types of test stations 12 and 14 that test respective products 24 and 36, types of fixtures 25 and 35 used with the respective products 24 and 36, the unique files listing, and the shared files listing. During the course of development of a test solution, the relationships are nebulous or constantly evolving. A rigorous process may be used to manage the relationships and revisions from release of the test solution to production of products 24 and 36. However, such a rigorous process may not be desirable during development of the test solution. During the development, it may be desirable for the developer to add the relationships intermittently as they are determined and to change the relationships as appropriate. Additionally, once the developer has created a test solution and tested a particular configuration, the developer can release the test solution without introducing errors during the release. The development system 70 facilitates this process.

Pre-release tool 74 parses developer file 80 and checks whether data items, such as products 24 and 36 to be tested, revisions of the products 24 and 36, instruments 26 and 34 used to test respective products 24 and 36, types of test stations 12 and 14 that test respective products 24 and 36, types of fixtures 25 and 35 used with respective products 24 and 36, the unique files listing, and the shared files listing are stored within TMS file server 71. As an example, pre-release tool 74 checks whether a product 24 is stored within developer file 80 and the product 24 is not stored within TMS database 73. To check whether the data items are stored in developer file 80, pre-release tool 74 compares the data items within developer file 80 with EFS 38, EFS 40, TPS 42, or TPS 44 stored in TMS database 73.

Any discrepancies from the comparison are highlighted so that the developer can take an appropriate action. All discrepancies are resolved prior to a release of products 24 and 36, instruments 26 and 34, types of test stations 12 and 14, types of fixtures 25 and 35, the unique files listing, or the shared files listing. Optionally, some (but not all) of the discrepancies may be resolved prior to releasing the data items from developer file 80 to TMS database 73. If the data items in developer file 80 are not stored within TMS database 73, pre-release tool 74 is used manually to release the data items to TMS file server 71. Alternatively, when the data items stored within developer file 80 are not stored within TMS database 73, the pre-release tool 74 automatically releases the data items to TMS file server 71. Until the data items are released, no links exist between developer file 80 and TMS database 73. Thus, a change in data items within the developer file 80 will not affect data items within the TMS database 73. At a time of release of the data items, the relationships captured in developer file 80 are created in TMS database 73.

During a release of the data items, TMS administration tool 72 copies the data items from development SCCS 76 to a space located on TMS file server 71 and that is allocated for the data items. During the release of the data items, TMS administration tool 72 also configures TMS database 73 to capture all of the relationships captured by developer file 80. Moreover, during the release, TMS administration tool 72 configures TMS database 73 by reading from developer file 80 and creating EFS 38, EFS 40, TPS 42, or TPS 44 based on the relationships in developer file 80. The reading and creating operations ensure an error free transition from a test phase of products 24 and 36 to production of the products 24 and 36. The reading and creating operations also ensure that a test solution that runs correctly using developer file 80 will also run correctly once EFS 38, EFS 40, TPS 42, and TPS 44 are made available to respective test stations 12 and 14.

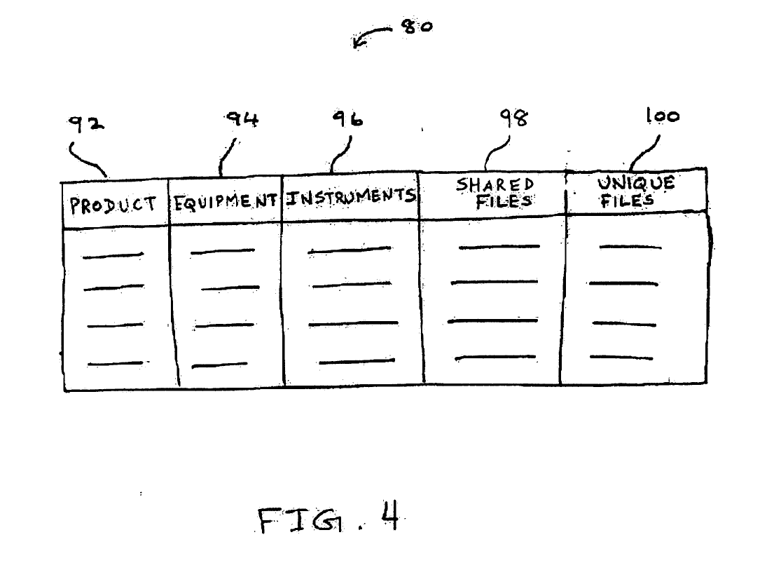

FIG. 4 shows an embodiment of developer file 80 which includes listings, such as a product listing 92, an equipment listing 94, an instruments listing 96, a shared files listing 98, and a unique files listing 100. The listings identify hardware components, such as instruments 26 and 34, instrument drivers, products 24 and 36, and any associated software components that control the hardware components. The listings are manually entered by the developer as a test solution is being created.

Product listing 92 lists all products and revisions of the products that are tested by the test solution. An example of product listing 92 is shown in Table 1 below.

TABLE 1

| Part number | Revision |
|---|---|
| 81.5508A | A |
| 81.5508A | B |

Equipment listing 94 identifies types of test stations and fixtures need for the test solution. An example of equipment listing 94 is shown in

TABLE 2

| Part number | Revision |
|---|---|
| Station type X | A |
| Fixture Y | B |

Instruments listing 96 lists instruments used by the test solution. Instruments listing 96 can be a subset of instruments for a particular type of test station. An example of instruments listing 96 is shown in Table 3 below.

TABLE 3

| Identifier | Name | Type |
|---|---|---|
| HP34401 | Multimeter | GPIB |
| HP6624A | Powersupply | GPIB |

Unique files listing 100 identifies software components unique to the test solution. An example of unique files listing 100 is shown in Table 4 below.

TABLE 4

| File name | Source path | Destination path |
|---|---|---|
| SolutionCode.dll | K:/solution/abc | C:/working/ |
| Specifications.txt | K:/solution/abc | C:/working/ |

The source path provided for each unique file in unique files listing 100 identifies a location in TMS file server 71 where the unique files are stored. The destination path provided for each unique file identifies a location in memory 30 of computer station 22 where the unique files are to be downloaded.

Shared files listing 98 identifies software components that are used by multiple test solutions. An example of shared files listing 98 is provided in Table 5 below.

TABLE 5

| File name | Source path | Destination path |
|---|---|---|
| InstrumentX.dll | K:/drivers/X | C:/Program Files |
| CommDriverY.dll | K:/drivers/Y | C:/working/ |

The source path provided for each common file in shared files listing 98 identifies a location in the TMS file server 71 where the shared files are stored. The destination path provided for each common file identifies a location within memory 30 of computer station 22 where the shared files are to be downloaded.

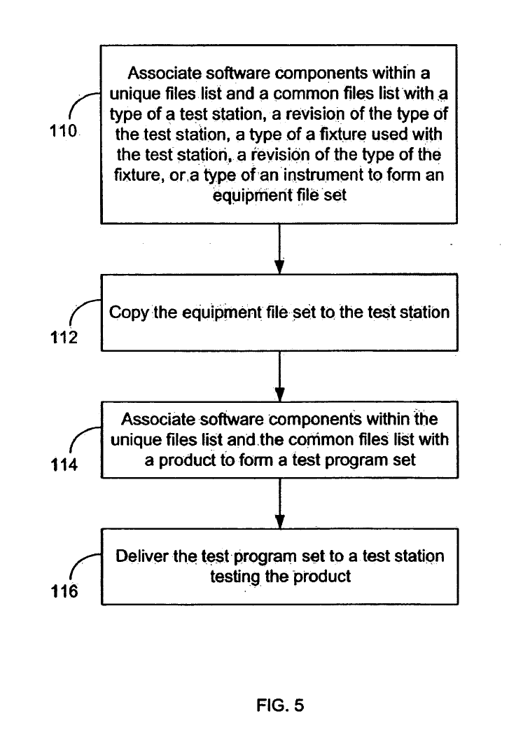

FIG. 5 is a flowchart of a method for developing software components. In 110, software components within a unique Files list and a common Files list are associated with a type of a test station, a revision of the type of test station, a type of fixture used with the test station, a revision of the type of fixture and/or a type of instrument to form an EFS. In 112, the EFS is copied to the test station. In 114, software components within the unique files list and the common files list are associated with a product to form a TPS. In 116, the TPS is delivered to a test station testing the product.

Next, the method of FIG. 5 is explained where implemented with the development system 70 of FIG. 3. At a time of release, software components within unique files listing 100 and shared files listing 98 are associated, in 110, with a type of test station 12, a revision of the type of test station 12, a type of fixture 25 used with computer station 22 and instrument 26, a revision of the type of fixture 25, or a type of instrument 26. The software components are combined in 110 to form EFS 38. Similarly, software components within unique files listing 100 and shared files listing 98 are associated, in 110, with a type of test station 14, a revision of the type of test station 14, a type of fixture 35 used with computer station 32 and instrument 34, a revision of the type of fixture 35, or a type of instrument 34. The software components are combined, in 110, to form EFS 40. Upon establishing a connection between test station 12 and TMS file server 71, EFS 38 is copied, in 112, from the TMS file server to memory 30 of the test station. Similarly, upon establishing a connection between test station 14 and TMS file server 71, EFS 40 is copied, in 112, from the TMS file server to a memory (not shown) of the test station.

In addition, at a time of release, software components that are within unique files listing 100 and shared files listing 98 are associated, in 114, to the particular product 24 to form TPS 42. Similarly, at a time of release, software components within unique files listing 100 and shared files listing 98 are associated, in 114, to the particular product 36 to form EFS 40. When TPS 42 is desired at test station 12, TMS file server 71 delivers TPS 42, in 116, to an appropriate location within memory 30 of computer station 22 as identified at a time of release. Similarly, when TPS 44 is desired at test station 14, TMS delivers, in 116, the TPS to an appropriate location within the memory of computer station 32 as identified at a time of release.

Technical effects of the herein described systems and methods for distributing software components include grouping software components into sets and delivering the sets to respective test stations 12 and 14. The systems are able to distinguish software components both on a per test station and per product basis. Distinctions between the software components develop over weeks or months. During the course of the development, the developers determine placement of the software components in different categories. The herein described systems and methods enable a dynamic delivery of permutations of the software components to the test stations upon request.

While the invention has been described in terms of various specific embodiments, those skilled in the art will recognize that the invention can be practiced with modification within the spirit and scope of the claims.

1. A method for distributing software components to computer stations that analyze products, said method comprising:
obtaining a software component including information used by a computer station which communicates with a test station to analyze a product; and
distributing the software component to the computer station automatically based on at least one of an identification of the test station and an identification of the product.

2. A method in accordance with claim 1 wherein said obtaining step comprises downloading, to the computer station, an equipment file set including said software component, said equipment file set directing the computer station to operate an instrument, said equipment file set being uniquely associated with the computer station and independent of the product.

3. A method in accordance with claim 1 wherein an instrument is used to test the product and said obtaining step comprises downloading at the computer station an equipment file set including said software component, said equipment file set directing the computer station to analyze the product, said equipment file set being uniquely associated with the computer station and the instrument and said equipment file set being independent of the product.

4. A method in accordance with claim 1 wherein said obtaining step comprises downloading at the computer station a test program set, said test program set directing the computer station to analyze the product, and said test program set being uniquely associated with the product and being associated with the computer station.

5. A method in accordance with claim 1 wherein an instrument is used to test the product, said obtaining step comprises downloading at the computer station a test program set, said test program set directing the computer station to analyze the product, and said test program set being uniquely associated with the product and being associated with the computer station and the instrument.

6. A method in accordance with claim 1 further comprising testing the product with an instrument based on the software component, wherein the instrument is at least one of a power supply, a communication analyzer, a signal generator, and a frequency counter.

7. A method in accordance with claim 1 wherein said obtaining step comprises downloading at the computer station at least one of a communication file, a configuration file, a calibration file, a test executive file, a test sequence file, a specification file, and a test step execution file.

8. A method in accordance with claim 1 wherein an instrument is used to test the product and further comprising storing in a database multiple equipment file sets, each equipment file set including at least one file identifying communications protocols between the computer station, the product and the instrument used to test the product.

9. A method in accordance with claim 1 further comprising storing in a database multiple equipment file sets, each equipment file set including at least one file identifying a calibration for an instrument to be used by the computer station to analyze the product.

10. A method in accordance with claim 1 wherein the information relates to analyzing at least one of a printed circuit board assembly, a combination of the printed circuit board assemblies, a module, a circuit pack, a field replaceable unit (FRU), a processor, a memory, and a cable.

11. A method in accordance with claim 1 further comprising storing, in a database, multiple test program sets, each of which includes at least one test step execution file that identifies steps to be executed by an instrument configured to test the product, wherein said obtaining step comprises accessing the test step execution file.

12. A method in accordance with claim 1 wherein said obtaining step comprises accessing, by the computer station, a management file server to download software component updates.

13. A method in accordance with claim 1 further comprising storing a relationship between the software components, products, instruments, and computer stations.

14. A method in accordance with claim 1 further comprising storing in a database information identifying multiple products, test stations used to test each product, instruments used to test the products, and fixtures used to hold the products.

15. A management system database configured to be used with a computer station that operates an instrument when analyzing a product, the database storing software components that are configured to be executed by the computer station to communicate with and operate the instrument in order to analyze the product, said database automatically accessing said software components based on identification of at least one of the computer station, the instrument and the product.

16. A database in accordance with claim 15 wherein said software components are organized into at least one equipment file set defining a station specific test solution to be executed by the computer station to direct the instrument to perform a test solution, said equipment file set being uniquely associated with the computer station and the instrument, said equipment file set being independent of the product.

17. A database in accordance with claim 15 wherein said software components are organized into at least one test program set that defines a product specific test solution to be executed by the computer station to direct the instrument to perform a test solution on the product, said test program set being uniquely associated with the product, said test program set being associated with the instrument and the computer station.

18. A database in accordance with claim 15 wherein said software components correspond to at least one of a communication file, a configuration file, a calibration file, a test executive file, a test sequence file, a specification file, and a test step execution file.

19. A database in accordance with claim 15 wherein said software components are configured to control the computer station to analyze at least one of a printed circuit board assembly, a combination of printed circuit board assemblies, a module, a circuit pack, a field replaceable unit (FRU), a processor, a memory, and a cable.

20. A database in accordance with claim 15 wherein said software components define an equipment file set that, when executed by the computer station, calibrates an instrument to execute a test sequence.

21. A system comprising:
a computer station configured to control operation of an instrument as the instrument analyzes a product, said computer station controlling the instrument based on at least one of an equipment file set and a test program set; and
a management system database in communication with said computer station, said database storing said at least one of an equipment file set and test program set, said database being accessible by said computer station, wherein said computer station controls said instrument during analysis of the product based on said at least one of an equipment file set and a test program set.

22. A system in accordance with claim 21 wherein said test program set includes a set of software components that are specific to the product and associated with at least one of said computer station and said instrument.

23. A system in accordance with claim 21 further comprising a test station communicating with said computer station and said instrument, and said equipment file set including a set of software components associated with said test station and independent of said product.

24. A system in accordance with claim 21 wherein said product is one of a printed circuit board assembly, a module, a circuit pack, a field replaceable unit (FRU), a processor, a memory, and a cable.

25. A system in accordance with claim 21 wherein the equipment file set includes at least one of a communication file, a configuration file, a calibration file, a test executive file, a test sequence file, and a specification file.

26. A system in accordance with claim 21 further comprising a developer file that enables a user to track relationships between said instrument and said computer station.

27. A system in accordance with claim 21 further comprising a pre-release tool that is used to release information generated in a developer file.

28. A system for developing software components, said system comprising:
a test station communicating with a computer station; and
a source code control system permitting a user to develop software components that, when used by said computer station, directs said computer station to control an instrument during analysis of a product, wherein said source code control system is used to develop a relation between an identification of the test station and an identification of the product.

29. A system in accordance with claim 28 further comprising at least one of:
an equipment file set that is uniquely associated with said test station and independent of said product; and
a test program set that is uniquely associated with said product and associated with said test station.

30. A system in accordance with claim 28 further comprising:
a database; and
a pre-release tool that parses a developer file created by the user to track relationships, wherein said pre-release tool parses to check for data items within said developer file with respect to pre-existing information within said database.

31. A system in accordance with claim 28 further comprising a workbook configured to create equipment file sets and test program sets in connection with new solutions configured to test said product.

32. A system in accordance with claim 28 further comprising an equipment file set that includes at least one file including a test solution executed by a computer station, said computer station directs an instrument to test said product, said equipment file set being uniquely associated with at least one of said computer station and said instrument, and said equipment file set being independent of said product.

33. A system in accordance with claim 28 further comprising a test program set that includes at least one file including a test solution executed by a computer station, said computer station directs an instrument to test the product, said test program set being uniquely associated with said product, and said test program set being associated with at least one of said instrument and said computer station.
